(19) United States
(12) Patent Application Publication
(10) Pub. No.: US 2015/0177523 A1
(43) Pub. Date: Jun. 25, 2015

(54) REFLECTOR UNIT, APPARATUS AND METHOD OF LIGHT BEAM SHAPING

(71) Applicants: HISENSE CO., LTD., Qingdao (CN); HISENSE USA CORPORATION, Suwanee, GA (US); HISENSE INTERNATIONAL CO., LTD., Qingdao (CN)

(72) Inventor: Youliang Tian, Qingdao (CN)

(21) Appl. No.: 14/524,883

(22) Filed: Oct. 27, 2014

(30) Foreign Application Priority Data
Dec. 20, 2013 (CN) 201310708100.5

(51) Int. Cl. G02B 27/09; G02B 27/14

(52) U.S. Cl. CPC G02B 27/0977; G02B 27/14

(57) ABSTRACT

Certain aspects of the disclosure relates to a light beam shaping apparatus, which includes at least one reflector unit disposed on a light beam transmission optical path. Each of the at least one reflector unit includes at least two reflectors. Each of the at least two reflectors includes a reflector body; a reflecting surface disposed on the reflector body; and a fixing portion supporting the reflector body. The reflecting surfaces of the at least two reflectors are disposed on a same plane.

### CROSS-REFERENCE TO RELATED APPLICATION

This application claims the priority to Chinese Patent Application No. 201310708100.5, filed on Dec. 20, 2013, in the State Intellectual Property Office of P.R. China, which is hereby incorporated herein in its entirety by reference.

### FIELD OF THE DISCLOSURE

The present disclosure relates to optoelectronic technology, and more particularly, to a light beam shaping apparatus and a method thereof.

### BACKGROUND

Currently, with the rapid development of projection display products, the brightness thereof has improved incessantly. Light sources being used by the projection display products, such as the light emitting diodes (LEDs) of three primary colors, emit spatial light beams with poor beam quality due to the relatively large etendue of the beams, which affects the performance thereof in high-brightness output operations.

For example, to excite phosphor powders with laser beams, the power of lasers used for excitation is generally in the range of dozens of watts or more. A projector with a laser as the light source generally uses a laser beam to excite a phosphor powder wheel to generate the required light for display purposes. When there is a demand for high brightness performance, the required power of the laser may reach dozens of watts or even more than 100 watts. Such high power of the laser is generally obtained by a combination of light beams emitted by many low-power laser devices. Each of these laser devices is independent from each other, and respectively emits an individual laser beam before the combining and shaping of the light beams, and all the laser beams respectively emitted are combined and shaped to form a laser beam with a small spot.

### SUMMARY

One aspect of the present disclosure relates to a light beam shaping apparatus, which includes at least one reflector unit disposed on a light beam transmission optical path, where each of the at least one reflector unit includes at least two reflectors. Each of the at least two reflectors includes: a reflector body; a reflecting surface disposed on the reflector body; and a fixing portion supporting the reflector body, where the reflecting surfaces of the at least two reflectors are disposed on a same plane.

In certain exemplary embodiments, the at least one reflector unit includes at least two reflector units, including a first reflector unit and a second reflector unit, where the reflecting surfaces of the reflectors of the first reflector unit are disposed on a same first plane, and the reflecting surfaces of the reflectors of the second reflector unit are disposed on a same second plane, where a first interval exists between two adjacent reflectors of the second reflector unit on the second plane, and the reflecting surface of at least one of the reflectors of the first reflector unit defines a reflection optical path passing through the first interval.

In certain exemplary embodiments, the at least one reflector unit includes at least two reflector units, including a first reflector unit and a second reflector unit, where the reflecting surfaces of the reflectors of the first reflector unit are disposed on a same first plane, and the reflecting surfaces of the reflectors of the second reflector unit are disposed on a same second plane, where the reflecting surface of at least one of the reflectors of the first reflector unit defines a reflection optical path passing along an outer side of a fringe reflector of the reflectors of the second reflector unit.

In certain exemplary embodiments, the first plane is parallel to the second plane.

In certain exemplary embodiments, the reflection optical paths within all of the at least one reflector unit are parallel to each other.

In certain exemplary embodiments, for at least one of the at least one reflector unit, the fixing portions of the reflectors of the same reflector unit are integrally formed and interconnected.

In certain exemplary embodiments, a second interval exists between two adjacent reflectors of the first reflector unit on the first plane, and the second interval is smaller than the first interval on the second plane between the two adjacent reflectors of the second reflector unit.

In certain exemplary embodiments, a width of the reflecting surface of each one of the reflectors of the first reflector unit is greater than a width of each one of the reflectors of the second reflector unit.

Another aspect of the present disclosure relates to a method of light beam shaping for a laser light source, which includes:

dividing all light beams emitted by the laser light source into N parts, corresponding to N reflector units of a first group respectively, where each of the N reflector units of the first group has at least two reflectors, each of the reflectors of each of the N reflector units of the first group is disposed on a same plane, and N is a positive integer;

directing the N-th part of the light beams emitted by the laser light source to being incident to the N-th reflector unit of the first group, where each of the reflectors of the N-th reflector unit of the first group reflects the incident light beams at a first predetermined angle, a part of or all of the reflectors of the N-th reflector unit of the first group reflects a plurality of the incident light beams, and all of or a part of the reflected light beams pass through intervals between the reflectors of the reflector units of the first group including the (N−1)-th reflector unit to the first reflector unit;

directing the (N−1)-th part of the light beams emitted by the laser light source to being incident to the (N−1)-th reflector unit of the first group, where each of the reflectors of the (N−1)-th reflector unit of the first group reflects the incident light beams at the first predetermined angle, a part of or all of the reflectors of the (N−1)-th reflector unit of the first group reflects a plurality of the incident light beams, and all of or a part of the reflected light beams pass through the intervals between the reflectors of the reflector units of the first group including the (N−2)-th reflector unit to the first reflector unit; and

directing the first part of the light beams emitted by the laser light source to being incident to the first reflector unit of the first group, where each of the reflectors of the first reflector unit of the first group reflects the incident light beams at the first predetermined angle, a part of or all of the reflectors of the first reflector unit of the first group reflects a plurality of the incident light beams, and all of the reflected light beams directly combine with the reflected light beams reflected by all other reflector units of the first group;

where after performing the shaping steps, all of the light beams emitted by the laser light source are transmitted towards a same direction, and a portion of intervals between the light beams are adjusted.

In certain exemplary embodiments, the method further includes: re-shaping the shaped light beams, including the following steps:

re-dividing the combined beams into M parts, corresponding to M reflector units of a second group respectively, where each of the M reflector units of the second group has at least two reflectors, each of the reflectors of each of the M reflector units of the second group is disposed on a same plane, and M is a positive integer;

directing the M-th part of the light beams emitted by the laser light source to being incident to the M-th reflector unit of the second group, where each of the reflectors of the M-th reflector unit of the second group reflects the incident light beams at a second predetermined angle, a part of or all of the reflectors of the M-th reflector unit of the second group reflects a plurality of the incident light beams, and all of or a part of the reflected light beams pass through intervals between the reflectors of the reflector units of the second group including the (M−1)-th reflector unit to the first reflector unit;

directing the (M−1)-th part of the light beams emitted by the laser light source to being incident to the (M−1)-th reflector unit of the second group, where each of the reflectors of the (M−1)-th reflector unit of the second group reflects the incident light beams at the second predetermined angle, a part of or all of the reflectors of the (M−1)-th reflector unit of the second group reflects a plurality of the incident light beams, and all of or a part of the reflected light beams pass through intervals between the reflectors of the reflector units of the second group including the (M−2)-th reflector unit to the first reflector unit; and

directing the first part of the light beams emitted by the laser light source to being incident to the first reflector unit of the second group, where each of the reflectors of the first reflector unit of the second group reflects the incident light beams at the second predetermined angle, a part of or all of the reflectors of the first reflector unit of the second group reflects a plurality of the incident light beams, and all of the reflected light beams directly combine with the reflected light beams reflected by all other reflector units of the second group;

where after performing the re-shaping steps, all of the light beams are transmitted towards a same direction, and a light spot size of the light beams is adjusted.

In a further aspect of the present disclosure, a reflector unit includes: at least two reflectors, where each of the at least two reflectors includes: a reflector body; a reflecting surface disposed on the reflector body; and a fixing portion supporting the reflector body, where the reflecting surfaces of the at least two reflectors are disposed on a same plane.

In certain exemplary embodiments, each of the reflectors is strip-shaped.

In certain exemplary embodiments, each of the reflectors is cantilevered by having one end being directly or indirectly connected to the corresponding fixing portion, and the other end being left unconnected.

In certain exemplary embodiments, the fixing portions of the at least two reflectors are integrally formed.

In certain exemplary embodiments, an interval exists between two adjacent reflectors of the at least two reflectors on the same plane. In one exemplary embodiment, the intervals between the adjacent reflectors on the same plane are equally sized. In one exemplary embodiment, the intervals between the adjacent reflectors on the same plane are not equally sized.

In certain exemplary embodiments, each of the reflectors has one end being directly or indirectly connected to the corresponding fixing portion.

These and other aspects of the disclosure will become apparent from the following description of several exemplary embodiments taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more exemplary embodiments of the disclosure and together with the written description, serve to explain the principles of the disclosure. Wherever possible, the same reference numbers are used throughout the drawings to refer to the same or like elements of an exemplary embodiment.

FIG. 1 schematically shows shaping of a beam shaping apparatus according to one exemplary embodiment of the present disclosure.

FIG. 2 schematically shows a reflector unit according to one exemplary embodiment of the present disclosure.

FIG. 3 schematically shows shaping of a beam shaping apparatus according to one exemplary embodiment of the present disclosure.

FIG. 4 schematically shows shaping of a beam shaping apparatus according to one exemplary embodiment of the present disclosure.

FIG. 5 schematically shows shaping of a beam shaping apparatus according to one exemplary embodiment of the present disclosure.

FIG. 6 schematically shows shaping of a beam shaping apparatus according to one exemplary embodiment of the present disclosure.

### DETAILED DESCRIPTION OF THE DISCLOSURE

The disclosure will now be described hereinafter with reference to the accompanying drawings, in which several exemplary embodiments of the disclosure are shown. This disclosure may, however, be embodied in many different forms and should not be construed as limited to the exemplary embodiments set forth herein.

The terms used in this specification generally have their ordinary meanings in the art, within the context of the disclosure, and in the context where each term is used. Certain terms that are configured to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various exemplary embodiments given in this specification.

It will be understood that, although the terms first, second, third etc. may be used herein to describe various elements, components, regions, layers and/or sections, these elements, components, regions, layers and/or sections should not be limited by these terms. These terms are only configured to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

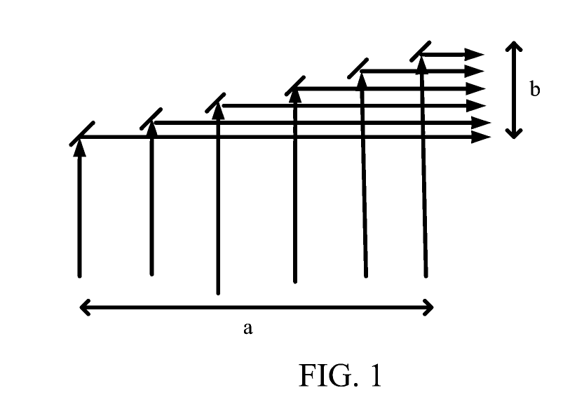

The description will be made as to the exemplary embodiments of the disclosure in conjunction with the accompanying drawings in FIGS. 1-6. It should be understood that exemplary embodiments described herein are merely used for explaining the disclosure, but are not intended to limit the disclosure. In accordance with the purposes of this disclosure, as embodied and broadly described herein, this disclosure, in certain aspects, relates to a beam shaping apparatus, a method of light beam shaping, and a reflector unit.

One aspect of the present disclosure relates to a light beam shaping apparatus, which includes at least one reflector unit disposed on a light beam transmission optical path, where each of the at least one reflector unit includes at least two reflectors. Each of the at least two reflectors includes: a reflector body; a reflecting surface disposed on the reflector body; and a fixing portion supporting the reflector body, where the reflecting surfaces of the at least two reflectors are disposed on a same plane.

Another aspect of the present disclosure relates to a method of light beam shaping for a laser light source, which includes:

dividing all light beams emitted by the laser light source into N parts, corresponding to N reflector units of a first group respectively, where each of the N reflector units of the first group has at least two reflectors, each of the reflectors of each of the N reflector units of the first group is disposed on a same plane, and N is a positive integer;

directing the N-th part of the light beams emitted by the laser light source to being incident to the N-th reflector unit of the first group, where each of the reflectors of the N-th reflector unit of the first group reflects the incident light beams at a first predetermined angle, a part of or all of the reflectors of the N-th reflector unit of the first group reflects a plurality of the incident light beams, and all of or a part of the reflected light beams pass through intervals between the reflectors of the reflector units of the first group including the (N−1)-th reflector unit to the first reflector unit;

directing the (N−1)-th part of the light beams emitted by the laser light source to being incident to the (N−1)-th reflector unit of the first group, where each of the reflectors of the (N−1)-th reflector unit of the first group reflects the incident light beams at the first predetermined angle, a part of or all of the reflectors of the (N−1)-th reflector unit of the first group reflects a plurality of the incident light beams, and all of or a part of the reflected light beams pass through the intervals between the reflectors of the reflector units of the first group including the (N−2)-th reflector unit to the first reflector unit; and

directing the first part of the light beams emitted by the laser light source to being incident to the first reflector unit of the first group, where each of the reflectors of the first reflector unit of the first group reflects the incident light beams at the first predetermined angle, a part of or all of the reflectors of the first reflector unit of the first group reflects a plurality of the incident light beams, and all of the reflected light beams directly combine with the reflected light beams reflected by all other reflector units of the first group;

where after performing the shaping steps, all of the light beams emitted by the laser light source are transmitted towards a same direction, and a portion of intervals between the light beams are adjusted.

In certain exemplary embodiments, the method further includes: re-shaping the shaped light beams, including the following steps:

re-dividing the combined beams into M parts, corresponding to M reflector units of a second group respectively, where each of the M reflector units of the second group has at least two reflectors, each of the reflectors of each of the M reflector units of the second group is disposed on a same plane, and M is a positive integer;

directing the M-th part of the light beams emitted by the laser light source to being incident to the M-th reflector unit of the second group, where each of the reflectors of the M-th reflector unit of the second group reflects the incident light beams at a second predetermined angle, a part of or all of the reflectors of the M-th reflector unit of the second group reflects a plurality of the incident light beams, and all of or a part of the reflected light beams pass through intervals between the reflectors of the reflector units of the second group including the (M−1)-th reflector unit to the first reflector unit;

directing the (M−1)-th part of the light beams emitted by the laser light source to being incident to the (M−1)-th reflector unit of the second group, where each of the reflectors of the (M−1)-th reflector unit of the second group reflects the incident light beams at the second predetermined angle, a part of or all of the reflectors of the (M−1)-th reflector unit of the second group reflects a plurality of the incident light beams, and all of or a part of the reflected light beams pass through intervals between the reflectors of the reflector units of the second group including the (M−2)-th reflector unit to the first reflector unit; and

directing the first part of the light beams emitted by the laser light source to being incident to the first reflector unit of the second group, where each of the reflectors of the first reflector unit of the second group reflects the incident light beams at the second predetermined angle, a part of or all of the reflectors of the first reflector unit of the second group reflects a plurality of the incident light beams, and all of the reflected light beams directly combine with the reflected light beams reflected by all other reflector units of the second group;

where after performing the re-shaping steps, all of the light beams are transmitted towards a same direction, and a light spot size of the light beams is adjusted.

In a further aspect of the present disclosure, a reflector unit includes: at least two reflectors, where each of the at least two reflectors includes: a reflector body; a reflecting surface disposed on the reflector body; and a fixing portion supporting the reflector body, where the reflecting surfaces of the at least two reflectors are disposed on a same plane.

FIG. 1 schematically shows shaping of a beam shaping apparatus according to one exemplary embodiment of the present disclosure. As shown in FIG. 1, light beams are emitted by laser devices (hereinafter lasers), and each beam of the incident laser beams is transmitted independently upwards. An overall width of the laser beams is a. For each beam, a reflector is added in front of the beam, such that each beam is reflected at different locations towards a same direction, thus being transmitted rightwards. After the reflection, the overall width of the laser beams becomes b, and it is shown that the width b is far shorter than a. This is an example of a simple beam shaping and combining process for the beams. The width a may be construed as a distance from a leftmost beam to a rightmost beam among all the beams, and the width b may be construed as a distance from a top beam to a bottom beam among all the reflected beams. All of the reflectors are disposed within a small range in a vertical direction. In other words, the vertical distance from the top reflector to the bottom reflector is short. Therefore, the wide incident light becomes a narrow emergent light after the reflection.

In certain exemplary embodiments, a laser array is used as the light source for the beam shaping apparatus. According to the arrangement of the laser array, the laser array may be divided into several major parts (for example, N parts, where N is a positive integer), and each part is subject to emit light beams to be reflected by a corresponding reflector unit, in which the reflectors are on a same plane. In other words, each of the N parts of divided light beams corresponds to one of the N reflector units. For each of the reflector units, the reflecting surfaces of the reflectors in a same reflector unit are disposed on a same plane, but an interval exists between each two adjacent reflectors on the same plane where the reflectors are located.

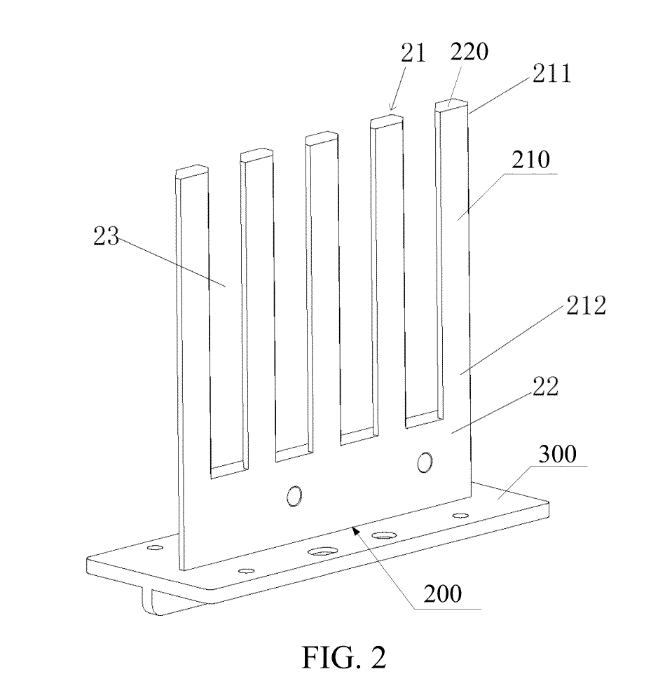

For example, as shown in FIG. 2, a reflector unit includes five reflectors 21. A rightmost reflector is used as an example. Each reflector 21 includes a reflector body 220, a reflecting surface 210, and a fixing portion 22. The fixing portions 22 of the reflectors 21 are integrally formed and interconnected, forming a collective fixing plate 200. The reflecting surface 210 is disposed on the reflector body 220, and these two components may be adhered together or may be integrally formed. The fixing portion 22 is connected to the reflector body 220 so as to support the reflector body 220.

It should be noted that, the positive integer N may be predetermined and may be subject to change. For example, one of the N reflector units may be subject to be skipped, such that the shaping operation is performed by the rest of the (N−1) reflector units. Alternatively, an additional reflector unit may be added to the beam shaping apparatus, where a transmission direction of the light beams corresponding to the additional reflector unit is consistent with transmission directions of the light beams being reflected at the predetermined angle by the other reflector units, such that the shaping operation is performed by the rest of the (N+1) reflector units.

It should be noted that, for one reflector unit, the fixing portions 22 of the reflectors 21 may be integrally formed and interconnected to form a collective fixing plate 200, as shown in FIG. 2. Alternatively, for one reflector unit, the fixing portions 22 of the reflectors 21 may be separately formed. In certain exemplary embodiments, in a beam shaping apparatus which includes multiple reflector units, some of the reflector units may have the fixing portions 22 of the reflectors 21 being integrally formed and interconnected to form the collective fixing plate 200, as shown in FIG. 2, and some other reflector units may have the fixing portions 22 of the reflectors 21 being separately formed. In certain exemplary embodiments, in a beam shaping apparatus which includes multiple reflector units, each of the reflector units may have the fixing portions 22 of the reflectors 21 being integrally formed and interconnected to form the collective fixing plate 200. In certain exemplary embodiments, in a beam shaping apparatus which includes multiple reflector units, each of the reflector units may have the fixing portions 22 of the reflectors 21 being separately formed.

In the reflector unit, the reflecting surfaces 210 of all reflectors 21 are on a same plane, and an interval 23 exists between each two adjacent reflectors on the same plane. These intervals may be equally sized or not equally sized. In this exemplary embodiment, each of the reflectors 21 is cantilevered by having an upper end of the reflector 21 being left unconnected, and a lower end of the reflector 21 being fixed. However, the present disclosure is not limited thereto. In certain exemplary embodiments, it is also feasible that the upper end of the reflector 21 is fixed and the lower end of the reflector is left unconnected. Alternatively, a plurality of fixing portions 22 may be disposed at both ends of the reflector 21, and thus no end of the reflector 21 is left unconnected. In short, one of ordinary skill in the art may understand that, under the premises that the required reflection function is not affected, the fixing portion 22 may be disposed at any location of the reflector 21, as long as the fixing portion 22 achieves the supporting function. The fixing plate 200 may be further fixed on a base body 300, thereby implementing the positioning of the reflector unit.

The reflecting surface 210 is a surface to provide the beam reflecting function, and any surface capable of implementing such function falls within the protection scope of the present disclosure. For example, the reflecting surface 210 may be implemented by a thin reflection coating layer, or may also be a component being formed of a reflective material. The area of the reflecting surface may be equally sized, or may be not equally sized, to a surface through which the reflecting surface is disposed onto the reflector body.

It should be noted that, the reflectors 21 in a reflector unit may be arranged such that only the reflecting surfaces 210 of a part of the reflectors 21 of the reflector unit are disposed on a same plane. For example, as shown in FIG. 2, it is possible to configure the reflector unit such that only the reflecting surfaces 210 of the three reflectors 21 in the middle thereof are disposed on the same plane. In this case, however, in this case, it can be construed that the reflector unit is actually formed by the three reflectors 21 in the middle. In other words, only the three reflectors 21 in the middle are construed as components of the reflector unit, which falls within the protection scope of the present disclosure.

In certain exemplary embodiments of the present disclosure, all intervals between adjacent reflectors may be equally sized or not equally sized. Manufacturing of the reflectors in such dimension may be performed according to actual needs. For example, each reflector may be used to reflect multiple beams. When the arrangement of the laser array is irregularly or randomly distributed, the intervals between the reflectors 21, i.e., the intervals 23, may be set to have the same size, or may be set to have different interval widths corresponding to the arrangement of the laser array. To improve the stability of the reflecting surfaces on the same plane, the fixing portion may be disposed at an upper end portion 211 of the reflector 21, or one or more fixing portions may be disposed at one or more locations between the upper end portion 211 and a lower end portion 212 of the reflector 21. Each reflector 21 may have a strip-shaped structure or the like. Alternatively, the reflector unit may be designed to have a mesh-shaped structure as a whole, as long as the reflected beams of reflectors of other reflector units disposed behind the reflector unit can pass through the intervals 23.

It should be noted that, based on the exemplary embodiment as shown in FIG. 2, the reflectors 21 may be interconnected to form an integral structure, by filling the intervals 23 with a filling material, provided that the filling material is a transparent material that allows light beams to pass therethrough, while the reflecting surfaces 220 of the reflectors 21 may perform reflection without having the light beams to pass therethrough. In this case, such embodiment still falls within the protection scope of the present disclosure. Further, for a reflector unit, when the reflecting surfaces 220 of only some of (and thus not all of) the reflectors 21 of the reflector unit are disposed on a same plane, it can be construed that the reflectors 21, with their reflecting surfaces 220 being disposed on the same plane, actually form the reflector unit, and such embodiment still falls within the protection scope of the present disclosure.

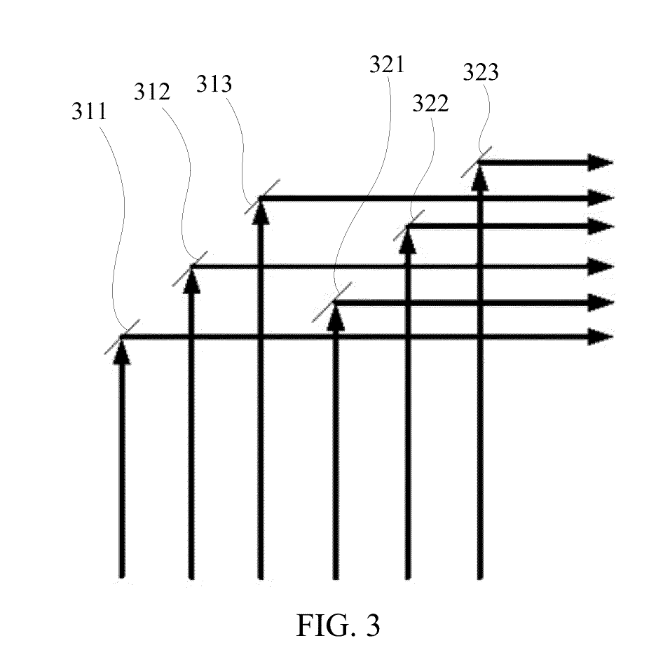

As shown in FIG. 3, an exemplary embodiment is provided with two reflector units being included. The three reflectors 311, 312, and 313, which are shown on the left side with their reflecting surfaces being disposed on a same plane, form a first reflector unit, and the three reflectors 321, 322, and 323, which are shown on the right side with their reflecting surfaces being disposed on a same plane, form a second reflector unit. As for the viewing angle of the reflector units, FIG. 3 can be regarded as a top view of FIG. 2, where the short sloping lines representing the reflectors may be construed as the end surfaces of the ends of the reflectors 21 being left unconnected, as shown in FIG. 2. The light beams being reflected by the reflectors in the same reflector unit are parallel to each other.

The three laser beams as shown on the left side of FIG. 3 are reflected by the first reflector unit. Because the reflecting surfaces of the three reflectors are on the same plane, a desirable consistent direction for the reflective beams may be achieved. The reflected laser beams are transmitted rightwards along an approximately same direction. Similarly, the three laser beams as shown on the right side of FIG. 3 undergo a similar process with the second reflector unit. The laser beams reflected by the first reflector unit pass through the intervals between adjacent reflectors in the second reflector unit, and are then combined with the laser beams reflected by the second reflector unit to form a more concentrated light beam, thereby implementing a basic beam combining process.

In this exemplary embodiment, the reflectors mounted on the same plane enables the desirable consistent direction for the reflective beams due to the fact that the degree of parallelism is better ensured with a coplanar structure of the reflectors. The laser beams are reflected towards the same direction, and then pass through the intervals between the reflectors in front thereof, such that the multiple laser beams may be combined. With such structure, any negative influence due to the arrangement of the reflectors on the shaped light beams and the spot size thereof after the shaping operations may be reduced. In one exemplary embodiment of the present disclosure, a deviation between spots of light beams which are reflected and combined based on the coplanar structure of the reflectors may be less than about 0.05 degrees. Accordingly, the deviation is significantly reduced, thus improving the optical quality of the light beams.

In certain embodiments of the present disclosure, a width of the reflecting surface of each one of the reflectors of the first reflector unit may be greater than a width of each one of the reflectors of the second reflector unit. The width of the reflector refers to a width of the portion of the reflector body that may block the light beams from being transmitted forward. When the width of the reflecting surface is the same as the width of the reflector, the width of the reflector refers to the width of the reflecting surface. On the other hand, when the width of the reflecting surface is not the same as the width of the reflector body, the width of the reflector is a maximum width of the portion of the reflector body that may block the light beams from being transmitted forward. The term “width” as used herein refers to a width perpendicular to a length direction of the reflector. Such arrangement is provided with the purpose of allowing the light beams reflected by the first reflector unit to pass through the intervals between the reflectors of the second reflector unit more easily.

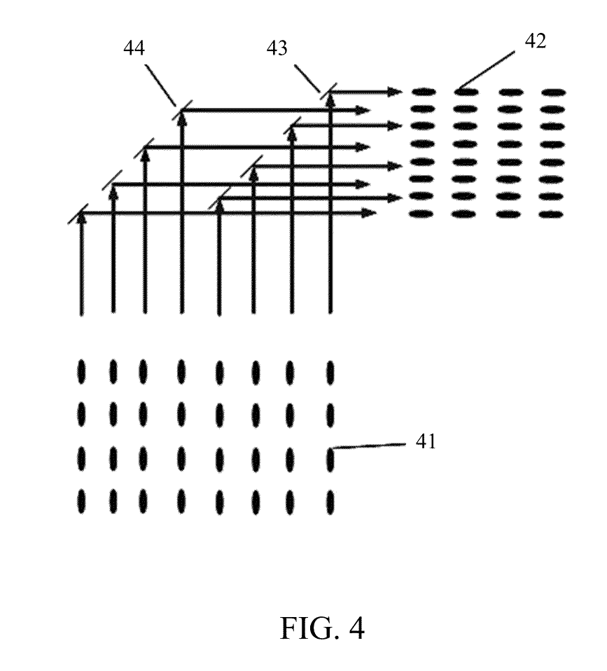

In one exemplary embodiment as shown in FIG. 4, a laser array is formed by four rows and eight columns of laser devices. The laser beams 41 being emitted by the laser array are transmitted upwards along a vertical direction. Assuming that an interval between each of two adjacent laser devices is 10 mm, the laser array has three row intervals within the four rows and seven column intervals within the eight columns, and thus the initial laser beams 41 emitted by the laser array may be regarded to cover an area of about 30 mm*70 mm approximately. All of the laser beams 41 are divided into a left part and a right part, and the reflectors are disposed on the transmission optical paths of the laser beams. The reflectors form two reflector units 43 and 44. Each reflector unit includes four of the reflectors, and each reflector reflects four beams of a corresponding column, such that the laser beams are reflected at an angle of 90 degrees to be transmitted rightwards. The four reflectors of the reflector unit 44 as shown on the left side reflect 16 beams on the left side such that the beams are transmitted rightwards, and the four reflectors of the reflector unit 43 as shown on the right side reflect 16 beams on the right side such that the beams are transmitted rightwards. The light beams reflected by the reflector unit 44 on the left side pass through the intervals between the reflectors of the reflector unit 43 on the right side to be interleaved with the beams reflected by the reflector unit 43, and are then combined with the beams reflected by the reflector unit 43 on the right side to form an integrally combined light beam.

The light beams reflected by the bottom reflector of the reflector unit 44 pass through an outer side (a lower side) of the bottom reflector of the reflector unit 43. In this exemplary embodiment, the light beams emitted by the laser light source are transmitted towards a same direction after the first shaping and combining operation, and the shaped beams 42 cover an area of approximately 30 mm*35 mm, where the dimension of 30 mm does not change, and the dimension of 70 mm is reduced to half to double the light beam density thereof.

In this exemplary embodiment, the light beam shaping apparatus, with the feature of each reflecting surface being disposed on a same plane to reflect multiple beams, may resolve the problem of beam shaping in a high brightness working state. Therefore, a consistent direction of the light beam during the beam combining process is better ensured, thus achieving better beam shaping performance. With the improved direction consistency of the combined beams, the efficiency of an optical system is also improved. In this case, fewer laser devices may be required to achieve the same brightness, thereby reducing the cost.

It should be noted that, as shown in FIG. 4, to better showing and making the exemplary embodiments of the present disclosure comprehensible, the initial laser beams 41 emitted by the laser device array, the shaped beams 42, and the reflector units 43 and 44 are shown in different angles of view, which should not limit in any negative ways the present disclosure. To further describe FIG. 4 as a whole, the initial laser beams 41 emitted by the laser device array and the shaped beams 42 adopt a cross-sectional view in which beams are transected, and the reflector units 43 and 44 adopt a front view (reference may be made to the top view as shown in FIG. 2). Each short sloping line in the reflector units 43 and 44 may represent a strip-shaped reflector as shown in FIG. 2.

For the description of the area being transformed from 30 mm*70 mm to 30 mm*35 mm, the dimension of 70 mm is converted in half to 35 mm because the two reflector units 43 and 44 are arranged in a front and rear structure, and the light beams reflected by the reflector unit 44 are interleaved within the beams reflected by the reflector unit 43. Therefore, the width of the seven column intervals (i.e., 7*10 mm) is compressed to be the width of the light beams reflected by one reflector unit. The width of the light beams reflected by one reflector unit, as shown in FIG. 4, is equal to a half of the width of the laser devices of the laser array, i.e., the width of a laser device array with four rows and four columns. Because there are three intervals in four columns, the width is 3*10 mm. However, the beams reflected by the bottom reflector of the reflector unit 44 pass through an outer side (the lower side) of the bottom reflector of the reflector unit 43, and therefore, one half of the 10 mm-interval, i.e., 5 mm, is increased approximately to the width. This, it can be construed that the overall width of the light beams after the shaping operation is 30 mm+5 mm=35 mm.

The dimension of 30 mm remains unchanged because in the laser device array with four rows and eight columns, the row intervals within the four rows are not compressed, as shown in FIG. 4. Therefore, this dimension remains unchanged.

In one exemplary embodiment of the present disclosure, when the laser beams 41 are arranged in a non-rectangular shape, for example, a rhombic shape, the reflectors on the fringes (i.e., the two sides) of the reflector unit 44 may each reflect only one light beam, while the reflectors in the middle reflect multiple beams.

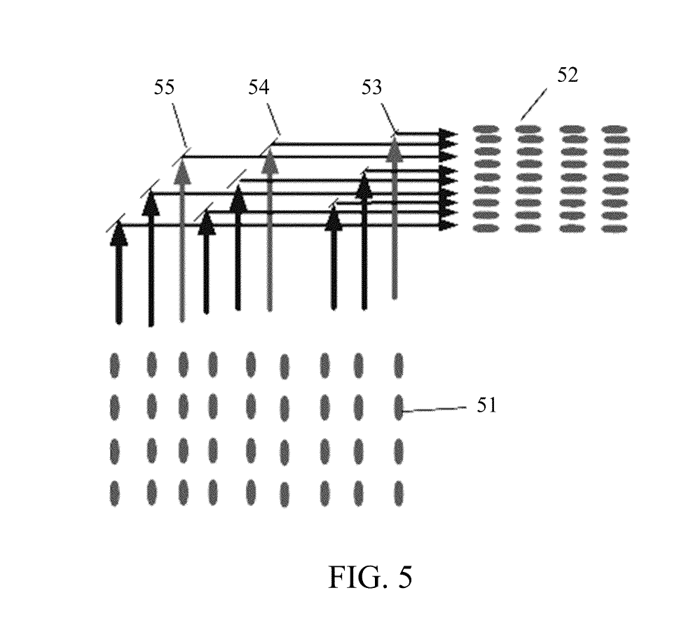

In one exemplary embodiment as shown in FIG. 5, one laser array is formed by four rows and nine columns of laser devices. Assuming that an interval between each of two adjacent laser devices is still 10 mm, the area covered by the initial laser beams 41 is approximately about 30 mm*80 mm. As shown in FIG. 5, the light beams emitted by the laser light source are divided into three parts, and three reflector units 53, 54, and 55 are respectively disposed on the transmission optical paths of the light beams, where the reflector units are respectively corresponding to three groups divided from the nine columns. Each group of laser beams includes 12 beams (4*3=12), which are all transmitted rightwards after being reflected and sequentially pass through the intervals or the outer sides of all of the reflectors on the right side. The area of a spot 52 of the combined light beams is approximately 30 mm*26.7 mm (26.7=80/3).

In this exemplary embodiment, when multiple reflector units are used, the reflector units are arranged in a parallel manner. Among the reflectors of each reflector unit, the interval (hereinafter the first interval) between the adjacent reflectors is greater than or equal to an interval (hereinafter the second interval) between the corresponding adjacent reflectors of another reflector unit which is behind the reflector unit. In other words, for a reflector unit (hereinafter the front reflector unit) that has at least one reflector unit (hereinafter the rear reflector unit) behind it, the second interval between the adjacent reflectors for the rear reflector unit is smaller than the first interval between the adjacent reflector for the front reflector unit. The width of a reflector of each reflector unit is not greater than the width of the reflecting surface of a reflector behind it, such that the light beams reflected by the other reflectors behind the reflector may pass through the reflector unit, thereby effectively compressing the beam intervals. As shown in FIG. 5, the width of each reflector of the reflector unit 53 is obviously shorter than the width of the reflectors of the reflector units 54 and 55. Reducing the width of the reflectors effectively allows increasing of the intervals between the reflectors.

In one exemplary embodiment of the present disclosure, the light beams may be combined and shaped two-dimensionally. For example, the spot after the shaping operation as shown in FIG. 4 still has large intervals in the unchanged dimension (i.e., the dimension of 30 mm that remains unchanged). In this case, a second shaping operation may be performed. In other words, the combined beams are divided again into M parts, which correspond to M reflector units respectively, where M is a positive integer. It should be noted that the M reflector units for performing the second shaping operation may belong to a different group from the N reflector units for performing the first shaping operation. To further compress the dimension of 30 mm, in the second shaping operation, the plane on which the reflecting surfaces of the reflector units are located may be orthogonal to the plane on which the reflecting surfaces of the reflector units used in the first shaping operation are located. Further, the light beams must be arranged to be incident onto the designated reflectors. After the second shaping, the original dimension of 30 mm may be compressed, thereby obtaining beams with a smaller spot.

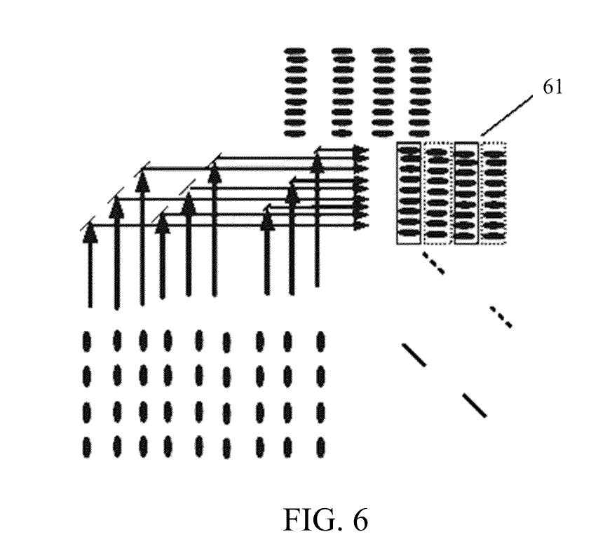

In one exemplary embodiment as shown in FIG. 6, after the shaping operation as shown in FIG. 5, two reflector units are further provided, and each reflector unit includes two reflectors. As shown in FIG. 6, the reflectors as shown in the blocks of solid lines form a reflector unit, and the reflectors as shown in the blocks of dashed lines form a reflector unit. The reflector units are arranged in a front-rear structure as mentioned above. The planes on which the reflecting surfaces of the two reflector units are located are orthogonal to the planes on which the reflecting surfaces of the three reflector units used in the previous shaping operation are located.

In this way, each reflector reflects 9 beams, and shaping is also performed to the other dimension. The area of the spot 61 after the second shaping operation by the two reflector units is approximately 15*26.7 mm.

In certain exemplary embodiments of the present disclosure, when two laser arrays are perpendicularly arranged, the light beams emitted by one of the laser arrays may be shaped first and combined with the light beams emitted by the other laser array. Then, a second shaping operation is performed. Alternatively, multiple addition shaping operations may be performed.

In certain exemplary embodiments, the reflector unit and the light beam shaping apparatus may be used in a laser display apparatus, where such laser display apparatus may be configured with one or more reflector units according to a single laser array or multiple laser arrays included in the laser display apparatus, so as to shape and combine the light beams emitted by the laser devices.

It should be noted that, embodiments of the present disclosure is not limited to shaping of laser beams, and may also be applied to perform shaping of other light beams required to be shaped.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The exemplary embodiments were chosen and described in order to explain the principles of the disclosure and their practical application so as to activate others skilled in the art to utilize the disclosure and various exemplary embodiments and with various modifications as are suited to the particular use contemplated. Alternative embodiments will become apparent to those skilled in the art to which the disclosure pertains without departing from its spirit and scope. Accordingly, the scope of the disclosure is defined by the appended claims rather than the foregoing description and the exemplary embodiments described therein.

What is claimed is:

1. A light beam shaping apparatus, comprising:
at least one reflector unit disposed on a light beam transmission optical path, wherein each of the at least one reflector unit comprises at least two reflectors, and each of the at least two reflectors comprises:
a reflector body;
a reflecting surface disposed on the reflector body; and
a fixing portion supporting the reflector body,
wherein the reflecting surfaces of the at least two reflectors are disposed on a same plane.

2. The light beam shaping apparatus according to claim 1, wherein the at least one reflector unit comprises at least two reflector units, including a first reflector unit and a second reflector unit, wherein the reflecting surfaces of the reflectors of the first reflector unit are disposed on a same first plane, and the reflecting surfaces of the reflectors of the second reflector unit are disposed on a same second plane,
wherein a first interval exists between two adjacent reflectors of the second reflector unit on the second plane, and the reflecting surface of at least one of the reflectors of the first reflector unit defines a reflection optical path passing through the first interval.

3. The light beam shaping apparatus according to claim 1, wherein the at least one reflector unit comprises at least two reflector units, including a first reflector unit and a second reflector unit, wherein the reflecting surfaces of the reflectors of the first reflector unit are disposed on a same first plane, and the reflecting surfaces of the reflectors of the second reflector unit are disposed on a same second plane,
wherein the reflecting surface of at least one of the reflectors of the first reflector unit defines a reflection optical path passing along an outer side of a fringe reflector of the reflectors of the second reflector unit.

4. The light beam shaping apparatus according to claim 2, wherein the first plane is parallel to the second plane.

5. The light beam shaping apparatus according to claim 3, wherein the first plane is parallel to the second plane.

6. The light beam shaping apparatus according to claim 1, wherein the reflection optical paths within all of the at least one reflector unit are parallel to each other.

7. The light beam shaping apparatus according to claim 1, wherein for at least one of the at least one reflector unit, the fixing portions of the reflectors of the same reflector unit are integrally formed and interconnected.

8. The light beam shaping apparatus according to claim 2, wherein a second interval exists between two adjacent reflectors of the first reflector unit on the first plane, and the second interval is smaller than the first interval on the second plane between the two adjacent reflectors of the second reflector unit.

9. The light beam shaping apparatus according to claim 2, wherein a width of the reflecting surface of each one of the reflectors of the first reflector unit is greater than a width of each one of the reflectors of the second reflector unit.

10. The light beam shaping apparatus according to claim 3, wherein a width of the reflecting surface of each one of the reflectors of the first reflector unit is greater than a width of each one of the reflectors of the second reflector unit.

11. A method of light beam shaping for a laser light source, comprising:
dividing all light beams emitted by the laser light source into N parts, corresponding to N reflector units of a first group respectively, wherein each of the N reflector units of the first group has at least two reflectors, each of the reflectors of each of the N reflector units of the first group is disposed on a same plane, and N is a positive integer;
directing the N-th part of the light beams emitted by the laser light source to being incident to the N-th reflector unit of the first group, wherein each of the reflectors of the N-th reflector unit of the first group reflects the incident light beams at a first predetermined angle, a part of or all of the reflectors of the N-th reflector unit of the first group reflects a plurality of the incident light beams, and all of or a part of the reflected light beams pass through intervals between the reflectors of the reflector units of the first group including the (N−1)-th reflector unit to the first reflector unit;
directing the (N−1)-th part of the light beams emitted by the laser light source to being incident to the (N−1)-th reflector unit of the first group, wherein each of the reflectors of the (N−1)-th reflector unit of the first group reflects the incident light beams at the first predetermined angle, a part of or all of the reflectors of the (N−1)-th reflector unit of the first group reflects a plurality of the incident light beams, and all of or a part of the reflected light beams pass through the intervals between the reflectors of the reflector units of the first group including the (N−2)-th reflector unit to the first reflector unit; and
directing the first part of the light beams emitted by the laser light source to being incident to the first reflector unit of the first group, wherein each of the reflectors of the first reflector unit of the first group reflects the incident light beams at the first predetermined angle, a part of or all of the reflectors of the first reflector unit of the first group reflects a plurality of the incident light beams, and all of the reflected light beams directly combine with the reflected light beams reflected by all other reflector units of the first group;
wherein after performing the shaping steps, all of the light beams emitted by the laser light source are transmitted towards a same direction, and a portion of intervals between the light beams are adjusted.

12. The method according to claim 11, further comprising:
re-shaping the shaped light beams, comprising the following steps:
re-dividing the combined beams into M parts, corresponding to M reflector units of a second group respectively, wherein each of the M reflector units of the second group has at least two reflectors, each of the reflectors of each of the M reflector units of the second group is disposed on a same plane, and M is a positive integer;
directing the M-th part of the light beams emitted by the laser light source to being incident to the M-th reflector unit of the second group, wherein each of the reflectors of the M-th reflector unit of the second group reflects the incident light beams at a second predetermined angle, a part of or all of the reflectors of the M-th reflector unit of the second group reflects a plurality of the incident light beams, and all of or a part of the reflected light beams pass through intervals between the reflectors of the reflector units of the second group including the (M−1)-th reflector unit to the first reflector unit;
directing the (M−1)-th part of the light beams emitted by the laser light source to being incident to the (M−1)-th reflector unit of the second group, wherein each of the reflectors of the (M−1)-th reflector unit of the second group reflects the incident light beams at the second predetermined angle, a part of or all of the reflectors of the (M−1)-th reflector unit of the second group reflects a plurality of the incident light beams, and all of or a part of the reflected light beams pass through intervals between the reflectors of the reflector units of the second group including the (M−2)-th reflector unit to the first reflector; and
directing the first part of the light beams emitted by the laser light source to being incident to the first reflector unit of the second group, wherein each of the reflectors of the first reflector unit of the second group reflects the incident light beams at the second predetermined angle, a part of or all of the reflectors of the first reflector unit of the second group reflects a plurality of the incident light beams, and all of the reflected light beams directly combine with the reflected light beams reflected by all other reflector units of the second group;
wherein after performing the re-shaping steps, all of the light beams are transmitted towards a same direction, and a light spot size of the light beams is adjusted.

13. A reflector unit, comprising:
at least two reflectors, wherein each of the at least two reflectors comprises:
a reflector body;
a reflecting surface disposed on the reflector body; and
a fixing portion supporting the reflector body,
wherein the reflecting surfaces of the at least two reflectors are disposed on a same plane.

14. The reflector unit according to claim 13, wherein each of the reflectors is strip-shaped.

15. The reflector unit according to claim 13, wherein each of the reflectors is cantilevered by having one end being directly or indirectly connected to the corresponding fixing portion, and the other end being left unconnected.

16. The reflector unit according to claim 13, wherein the fixing portions of the at least two reflectors are integrally formed.

17. The reflector unit according to claim 13, wherein an interval exists between two adjacent reflectors of the at least two reflectors on the same plane.

18. The reflector unit according to claim 17, wherein the intervals between the adjacent reflectors on the same plane are equally sized.

19. The reflector unit according to claim 17, wherein the intervals between the adjacent reflectors on the same plane are not equally sized.

20. The reflector unit according to claim 14, wherein each of the reflectors has one end being directly or indirectly connected to the corresponding fixing portion.
